(19) United States
(12) Patent Application Publication
(10) Pub. No.: US 2024/0055633 A1
(43) Pub. Date: Feb. 15, 2024

(54) METHOD FOR DETERMINING THE LENGTH AND/OR VOLUME OF THE PURGE PATH WITHIN A FUEL CELL SYSTEM

(71) Applicant: Robert Bosch GmbH, Stuttgart (DE)

(72) Inventor: Helerson Kemmer, Vaihingen (DE)

(21) Appl. No.: 18/255,475

(22) PCT Filed: Dec. 8, 2021
(86) PCT No.: PCT/EP2021/084730

§ 371 Date: Jun. 1, 2023

(30) Foreign Application Priority Data
Dec. 14, 2020 (DE) 10 2020 215 818.5

(51) Int. Cl. H01M 8/04992; H01M 8/04089; H01M 8/04302; H01M 8/0438; H01M 8/0444; H01M 8/04664; H01M 8/04746

(52) U.S. Cl. CPC H01M 8/04992; H01M 8/04097; H01M 8/04302; H01M 8/0441; H01M 8/04402; H01M 8/04462; H01M 8/04671; H01M 8/04761; H01M 2250/20

(57) ABSTRACT

The invention relates to a method for determining the length and/or volume of a purge path within a fuel cell system (100), the fuel cell system (1) comprising a fuel cell stack (101), an air path (10), an exhaust line (12), and a fuel line (20) with a recirculation loop (50). During the purging process, the H2 concentration is measured on an H2 sensor (45) in the exhaust line (12) and the length and/or volume of the purge path is/are determined as a function of the profile of the measured H2 concentration.

### BACKGROUND

The invention relates to a method for determining the length and/or volume of the purge path within a fuel cell system.

Hydrogen-based fuel cell systems are considered to be the mobility concept of the future since they only emit water as exhaust gas and allow for fast fueling times. Fuel cell systems need air and hydrogen for the chemical reaction within the cells. In order to supply the required amount of energy, the fuel cells arranged within a fuel cell system are interconnected to form so-called fuel cell stacks. Here, the waste heat of the cells is dissipated by means of a cooling loop and released to the environment. The hydrogen required for operating fuel cell systems is generally provided to the systems from high pressure tanks.

The purging strategy of a fuel cell system is usually time-based or model-based, e.g., by integrating the drawn current as an indication of the amount of nitrogen passing through the cathode, or the nitrogen passing through the cathode and thus diffused into the anode.

Publication DE 10 2006 013 699 A1 discloses a fuel cell system having a fuel cell and an actuating element actuated by a control unit for delivering residual gas from a stream of operating material of the fuel cell. It is characterized in that the control unit involves a control and/or regulation that takes into account the operating material concentration in the operating material flow.

### SUMMARY

The method according to the invention for determining the length and/or volume of a purge path within a fuel cell system, has the advantage that, during the purging process, the H2 concentration is measured on an H2 sensor in the exhaust line and the length and/or volume of the purge path is/are determined as a function of the profile of the measured H2 concentration.

Based on a deviation of the measured volume compared to an initially measured value of the volume or compared to a stored reference value of the volume, a clogging of the purge path can be identified.

Clogging can occur, for example, by icing upon startup/operation under freezing conditions or by age-related constrictions of the purge path, including the purge valve. A time-controlled purging strategy as described in the prior art remains ineffective in this case; the stack becomes irreparably damaged within minutes (sometimes even seconds).

With the method according to the invention, clogs in the purge path can be detected and countermeasures can be taken, for example, by an adjustment of the purging strategy, so that damage to the fuel cell stack does not occur.

The method according to the invention is inexpensive, because sensors already installed in the system can be used in order to determine the length and/or the volume and to detect a clog thereby, for example due to icing or age-related clogging. An H2 sensor used in order to determine the H2 concentration is installed in each fuel cell system, because the H2 concentration directed into the environment via the exhaust line is always measured for safety reasons.

By means of the described method, an insufficient purging is avoided with the adjustment of the purging strategy, i.e., a purging process in which nitrogen and water vapor are still present in the recirculation loop upon termination thereof. A possible consequence is a subsequent hydrogen depletion and associated degradation of the cells in the fuel cell stack.

If the recirculation loop is filled with pure hydrogen prior to the opening of the purge valve, the length and/or volume can be advantageously determined, because the density and dynamic viscosity for hydrogen can be accurately indicated in the equation system.

It is advantageous when, during the purging process, the mass air flow in the exhaust line is kept constant so as to prevent changes in the dilution conditions on the H2 sensor.

There is a further advantage when the measured volume of the purge path is compared to predetermined or initially measured values for the volume of the purge path, and a partial clogging of the purge path is detected based on a deviation. In this way, a partial clogging of the purge path can be detected early on, so that countermeasures can be initiated in a timely manner. This can in particular be an increase in the purge duration and/or a reduction in the purge interval.

In order to avoid insufficient purging and thus degradation of the cells in the fuel cell stack in case of partial clogging, the purge duration can be increased or the purge interval reduced.

The method according to the invention can in particular be used in fuel cell-powered motor vehicles. However, it is also conceivable to use the method in other fuel cell-powered transportation means, such as cranes, ships, rail vehicles, flying objects, or even in stationary fuel cell-powered objects.

### BRIEF DESCRIPTION OF THE DRAWINGS

The Figures Show:

FIG. 1 a schematic illustration of a fuel cell system according to the invention according to a first exemplary embodiment,

FIG. 2 a flowchart of the individual steps of a method according to the invention according to a first exemplary embodiment, and

FIG. 3 a measurement representing the H2 concentration in the recirculation loop and in the exhaust line during a purging operation.

### DETAILED DESCRIPTION

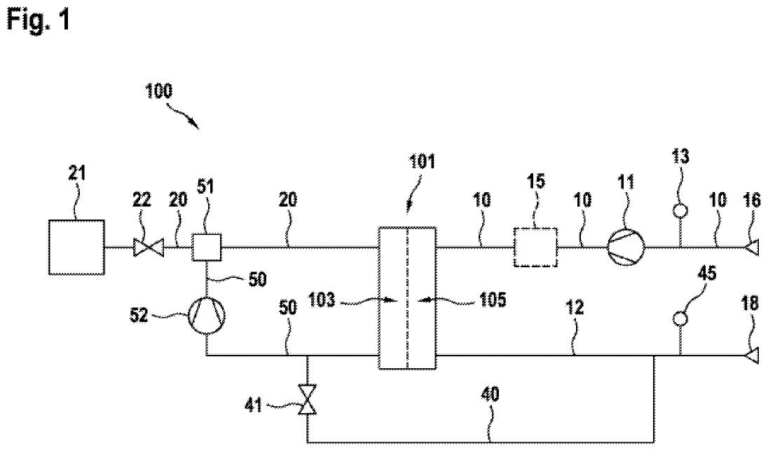

FIG. 1 shows a schematic topology of a fuel cell system 1 according to a first exemplary embodiment of the invention, having at least one fuel cell stack 101. The at least one fuel cell system 1 comprises an air path 10, an exhaust line 12, and a fuel line 20. The at least one fuel cell stack 101 can be used for mobile applications with a high power requirement, for example in trucks, or for stationary applications, for example in generators.

The air path 10 serves as an air supply line for supplying air from the environment to a cathode 105 of the fuel cell stack 101 via an inlet 16. An air sensor 13 can be optionally arranged in the air path 10, which determines the oxygen content of the air.

Components required for the operation of the fuel cell stack 101 are arranged in the air path 10. An air compressor 11 and/or compressor 11, which compresses and/or draws in the air in accordance with the respective operating conditions of the fuel cell stack 101, is arranged in the air path 10. A humidifier 15 which enriches the air in the air path 10 with a higher concentration of liquid can be arranged downstream of the air compressor 11 and/or compressor 11.

Further components, such as a filter and/or a heat exchanger and/or valves, can be provided in the air path 10 as well. Air containing oxygen is made available to the fuel cell stack 101 via the air path 10. The fuel cell system 1 can moreover comprise a cooling loop configured to cool the fuel cell stack 101. The cooling loop is not shown in FIG. 1, because it is not part of the invention.

A high pressure tank 21 and a shut-off valve 22 are arranged in the inlet of fuel line 20. Additional components can be arranged in the fuel line 20 so as to supply fuel to an anode 103 of the fuel cell stack 101 as needed.

To always adequately supply the fuel cell stack 101 with fuel, there is a need for an overstoichiometric metering of fuel via the fuel line 20. The excess fuel, and also certain amounts of water and nitrogen that diffuse through the cell membranes to the anode side, are recirculated in a recirculation loop 50 and mixed with the metered fuel from the fuel line 20.

Various components, such as a jet pump 51 operated with the metered fuel or a recirculation pump 52, can be installed in order to drive the flow in the recirculation loop 50. A combination of jet pump 51 and recirculation pump 52 are possible, as well.

Because the amount of water and nitrogen in the recirculation loop 50 increases more and more over time, the recirculation loop 50 has to be flushed periodically so that the performance of the fuel cell stack 101 does not decrease due to an excessive concentration of nitrogen in the fuel line 20.

A purge line 40 is arranged between the recirculation loop 50 and the exhaust line 12 so that the gas mixture can flow from the recirculation loop 50 into the exhaust line 12.

A purge valve 41, which can open and close the connection between the recirculation loop 50 and the exhaust line, 12 is arranged in the purge line 40. The purge valve 41 is typically opened for a short period of time, so that the gas mixture is fed into the exhaust line 12 via the purge line 40.

The exhaust line 12 serves to convey exhaust into the environment via an outlet 18. The exhaust gas comprises a gas mixture with constituents of air from the air path 10 and water. The exhaust gas of the exhaust line 12 can also contain hydrogen (H2), because portions of the hydrogen from the fuel line 20 can diffuse through the membrane of the fuel cell stack 101. Furthermore, hydrogen and a gas mixture with nitrogen can enter exhaust line 12 via the purge line 40.

An H2 sensor 45 is arranged in the exhaust line 12, which measures the concentration of hydrogen in the exhaust gas, because not too much hydrogen can be allowed to pass into the environment via the exhaust line 12. Furthermore, the formation of an explosive mixture must be avoided.

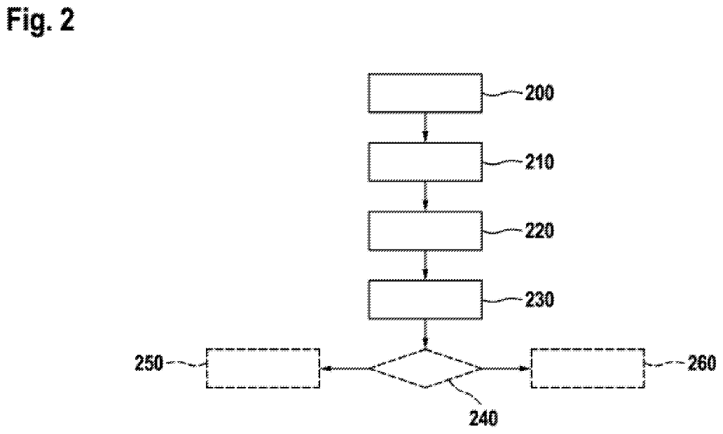

FIG. 2 shows a flowchart of the individual steps of the method according to the invention for determining the length and/or the volume of a purge path within a fuel cell system 100 according to a first exemplary embodiment.

The purge path is understood to mean a combination of the purge line 40 and a portion of the exhaust line 12 located between the confluence of the purge line 40 into the exhaust line 12 and the H2 sensor 45.

In the method, during the purging process, the H2 concentration is measured on the H2 sensor 45 in the exhaust line 12 and the length and/or volume of the purge path is/are determined as a function of the profile of the measured H2 concentration.

In a method step 200, the purging operation is initiated. This purging operation can be intentionally initiated in order to determine, for example, the length and/or volume at the start of the fuel cell system at the start of a ride or after a particular travel time.

To initiate the purging operation, the purge valve 41 is opened, and the current power stage of the fuel cell stack 101 is kept as constant as possible.

In a method step 210, the mass air flow in the exhaust line 12 is kept constant so as to prevent changes in the dilution conditions on the H2 sensor 45. This can be done, for example, by deliberately adjusting the air compressor 11 to a fixed power level.

In the method step 220, the H2 concentration in the exhaust gas measured during the purging process is measured and, if necessary, stored by the H2 sensor 45 at short time intervals or continuously.

In the method step 230, a period of time between the opening of the purge valve 41 and the increase in H2 concentration on the H2 sensor 45 is determined. With the help of this period of time and the values for the pressure in the recirculation loop 50 p_{recirculation loop} and the pressure in the exhaust line 12 p_{exhaust line}, the length and the volume of the purge path can be determined by taking into account the diffusion rate of hydrogen.

For example, the attached equation system can be solved according to the length L and/or the volume V_{purgepath}.

$${\dot{V}}_{in} = \frac{π {r}^{4}}{8 σ L} \cdot ( {p}_{Recirculationloop} - {p}_{Purgepath} ) \qquad ( 1 )$$

$${\dot{V}}_{out} = \frac{π {r}^{4}}{8 σ L} \cdot ( {p}_{Purgepath} - {p}_{Exhaustline} ) \qquad ( 2 )$$

$${\dot{n}}_{in} = {\dot{V}}_{in} \cdot {ρ}_{Anodegas} \cdot {μ}_{Anodegas} \qquad ( 3 )$$

$${\dot{n}}_{out} = {\dot{V}}_{out} \cdot {ρ}_{Purgegas} \cdot {μ}_{Purgegas} \qquad ( 4 )$$

$$( 1 ) {n}_{Purgepath} = {n}_{0} + {\int }_{0}^{t} ( {\dot{n}}_{out} - {\dot{n}}_{in} ) dt \qquad ( 5 )$$

$${p}_{Purgepath} = \frac{1}{{V}_{Purgepath}} \cdot R \cdot {n}_{Purgepath} \cdot T \qquad ( 6 )$$

$$( 2 ) {n}_{0} = \frac{{p}_{Exhaustline} \cdot {V}_{Purgepath}}{R \cdot T} \qquad ( 7 )$$

n: Number of mols [mol]
V: Volume [m3]
T: Temperature [K]
\dot{V}: Flow rate [m3/s]
r: Radius [m]
L: Length [m]
σ: Dynam. viscosity [bar s]
p: Pressure [bar]
\dot{n}: Molar flow [mol/s]
ρ: Density [g/m3]
μ: Molar mass [mol/g]

Here, for ρ_{Anodegas} and μ_{Anodegas}, the gas compositions in the recirculation loop are considered or approximated and for ρ_{Purgegas} and μ_{Purgegas}, the gas compositions at the outlet of the purge line 40 are considered or approximated.

In an alternative embodiment, in method step 240, it is checked whether the measured volume of the purge path matches the predetermined or initially measured value for the volume of the purge path. If there is a deviation, a partial clogging of the purge path can be assumed.

If there is clogging of the purge path, in method step 250, the purge duration is increased and/or the purge interval reduced. Otherwise, the purge duration and the purge interval are not changed in a method step 260.

In an alternative embodiment, the recirculation loop 50 is filled with pure hydrogen prior to the opening of the purge valve 41. This increases the measurement accuracy of the measurements, because otherwise a mixture of substances is present in the recirculation loop 50 and the diffusion velocity parameters must be adjusted as a function of the composition of the substances in the recirculation loop 50.

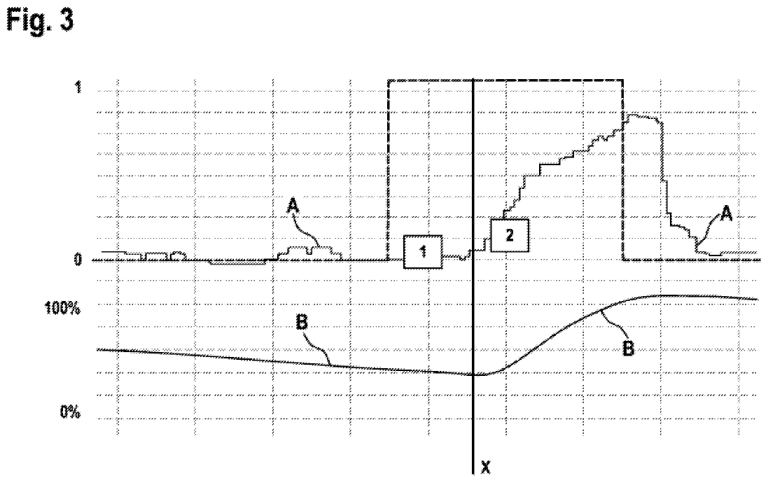

FIG. 3 shows a measurement that provides the physical background of the method according to the invention.

In the diagram, the dashed line represents the purging operation. At value 0, the purge valve 41 is closed, and at value 1, the purge valve 41 is open.

In the diagram, the upper solid line A represents the H2 concentration on the H2 sensor 45. No numerical values were specified here, because only the course of the measured H2 concentrations is required in order to explain the procedure.

In diagram B shown below, the H2 concentration in the recirculation loop 50 is shown; here, too, it is not about the explicit measured values but rather the profile of the measurement curve.

With the purging process shown in diagram A, the recirculation loop 50 is “purified” of nitrogen and water vapor. As a result, the H2 concentration in the recirculation circle 50 increases, as shown in curve B. The purging process is performed until the H2 concentration in the recirculation loop 50 has increased to 100%.

During the purging process, the following phases can be seen in curve A:

Dead time: There is no increase in the H2 concentration on the H2 sensor 45.

Filling of the purge path: A rapid increase in H2 concentration occurs in the H2 sensor 45.

Increase in H2 concentration in the recirculation loop 50: A moderate increase in H2 concentration occurs on the H2 sensor 45.

No further increase in H2 concentration in the recirculation loop 50 can be seen: A maximum plateau of the H2 concentration is achieved on the H2 sensor 45.

In phase 1, the hydrogen does not yet reach the H2 sensor 45, i.e., the time, H2 quantity, pressure differential, etc., are not sufficient for H2 molecules to completely pass through the purge path.

If the relevant parameters (length and volume of the purge path, pressure differential, etc.) for the throughput time of the hydrogen changes, the length of the phase 1 changes accordingly.

In phase 2, the H2 concentration rises on the H2 sensor 52. In this phase, the gas can flow from the recirculation loop 50 through the purge line 40. Because gases that have a lower H2 concentration than the gases in the recirculation loop 50 are also present within the purge line 40, the gas from the recirculation loop 50 is first strongly diluted. After an increasing through-flow, the H2 concentration in the purge line 40 increases, and it is rapidly adjusted to the H2 concentration of the recirculation loop 50. The duration and gradient of the increase in H2 concentration of this phase correlate with geometric parameters of the purge path, such as length and diameter, as well as deflections within the conduction system.

The transition between phase 1 and phase 2 is additionally highlighted by a perpendicular double-dash, which is designated with x, in the second diagram of FIG. 3.

1. A method for determining the length and/or volume of a purge path within a fuel cell system (100), wherein the fuel cell system (1) comprises a fuel cell stack (101), an air path (10), an exhaust line (12), and a fuel line (20) with a recirculation loop (50), the method comprising:
measuring, during a purging process, an H2 concentration via an H2 sensor (45) in the exhaust line (12), and
determining the length and/or volume of the purge path as a function of a profile of the measured H2 concentration.

2. The method according to claim 1,
wherein a period of time between the opening of a purge valve (41) and the increase in H2 concentration on the H2 sensor (45) is determined.

3. The method according to claim 1,
wherein the pressure in the recirculation loop (50) and the pressure in the exhaust line (12) are determined.

4. The method according to claim 1,
wherein, taking into account the diffusion rate of hydrogen, the length and/or the volume of the purge path is/are determined.

5. The method according to claim 1,
wherein the recirculation loop (50) is filled with pure hydrogen prior to the opening of the purge valve (41).

6. The method according to claim 1,
wherein, during the purging process, the mass air flow in the exhaust line (12) is kept constant so as to prevent changes in the dilution conditions on the H2 sensor (45).

7. The method according to claim 7,
wherein the measured volume of the purge path is compared to predetermined values for the volume of the purge path, and a partial clogging of the purge path is detected based on a deviation.

8. The method according to claim 1,
wherein the purge duration is increased and/or the purge interval is reduced when there is a clog.

9. The method according to claim 1,
wherein the method is applied in each purging operation or after predetermined time intervals in order to check for a clog.

10. The method according to claim 1,
wherein the method is carried out during startup of the fuel cell system for application of the parameters of the purge path and/or vehicle-specifically for adaptation of changed parameters.
